(19) United States
(12) Patent Application Publication
(10) Pub. No.: US 2025/0173127 A1
(43) Pub. Date: May 29, 2025

(54) CODE GENERATION USING MACHINE LEARNING MODELS

(71) Applicant: QUALCOMM Incorporated, San Diego, CA (US)

(72) Inventors: Weiliang ZENG, San Diego, CA (US); James Randall EZICK, Canonsburg, PA (US); Christopher LOTT, San Diego, CA (US); Joseph Binamira SORIAGA, San Diego, CA (US); Piero ZAPPI, La Jolla, CA (US); Mingu LEE, San Diego, CA (US); Arvind Vardarajan SANTHANAM, San Diego, CA (US)

(21) Appl. No.: 18/523,552

(22) Filed: Nov. 29, 2023

(51) Int. Cl. G06F 8/33

(52) U.S. Cl. CPC G06F 8/33

(57) ABSTRACT

Systems and techniques are described for performing code generating using machine learning models (e.g., large language models). For example, a computing device can generate, based on input data, second input data for a machine learning model. The computing device can generate, based on the second input data, a prompt. The computing device can apply a beam search with sampling on the prompt to generate a set of output samples. The computing device can further apply a static analysis to the set of output samples to generate a set of samples and can output the set of samples.

### TECHNICAL FIELD

The present disclosure generally relates to the use of large language models. For example, aspects of the present disclosure relate to systems and techniques for performing code generating using machine learning models (e.g., large language models).

### BACKGROUND

Machine learning models (e.g., deep learning models such as neural networks and large language models (LLMs)) can be used to perform a variety of tasks, including computer code generation, speech recognition, speech generation, depth estimation, detection and/or recognition (e.g., scene or object detection and/or recognition, speech recognition), pose estimation, image reconstruction, classification, three-dimensional (3D) modeling, dense regression tasks, data compression and/or decompression, image processing, among other tasks. Machine learning models can be versatile and can achieve high quality results in a variety of tasks.

LLMs are widely adopted and produce fluent and useful outputs. Use cases of LLMs can include text generation, machine translation/summarization, code generation, and so forth. Machine learning models (e.g., LLMs) served on cloud computing environments can be much larger than those deployed on edge devices. Empirical scaling law indicates that training loss scales as a power-law with model size, dataset size, and compute needs. Models such as LLMs can be large (e.g., include a large number of parameters). Further, the cost of inference of such models can grow quickly. Examples of large model sizes include 173 billion parameters for GPT-3 (Generative Pre-Trained Transformer), 530 billion parameters for the MT-NLG (Megatron-Turing Natural Language Generation), and 1.76 trillion (estimated) parameters for GPT-4. Such characteristics of machine learning models (e.g., LLMs) can limit acceptable performance of the models to devices or systems (e.g., cloud-based servers or server systems) with powerful computation and storage resources, rather than using other types of devices (e.g., edge devices).

### SUMMARY

Systems and techniques are described herein for performing code generating using machine learning models, such as large language models (LLMs). According to some aspects, an apparatus is provided to provide one or more syntax correct samples. The apparatus includes at least one memory and at least one processor coupled to the at least one memory and configured to: generate, based on input data, second input data for a machine learning model; generate, based on the second input data, a prompt; apply a beam search with sampling on the prompt to generate a set of output samples; apply a static analysis to the set of output samples to generate a set of samples; and output the set of samples.

According to some aspects, a method of providing one or more syntax correct samples is provided. The method includes: generating, based on input data, second input data for a machine learning model; generating, based on the second input data, a prompt; applying a beam search with sampling on the prompt to generate a set of output samples; applying a static analysis to the set of output samples to generate a set of samples; and outputting the set of samples.

According to some aspects, a non-transitory computer-readable medium storing instructions which, when executed by at least one processor, cause the at least one processor to: generate, based on input data, second input data for a machine learning model; generate, based on the second input data, a prompt; apply a beam search with sampling on the prompt to generate a set of output samples; apply a static analysis to the set of output samples to generate a set of samples; and output the set of samples.

According to some aspects, an apparatus to provide one or more syntax correct samples is provided. The apparatus includes: means for generating, based on input data, second input data for a machine learning model; means for generating, based on the second input data, a prompt; means for applying a beam search with sampling on the prompt to generate a set of output samples; means for applying a static analysis to the set of output samples to generate a set of samples; and means for outputting the set of samples.

According to some aspects, an apparatus is provided to generate an output from input data. The apparatus includes at least one memory and at least one processor coupled to the at least one memory and configured to: apply, by a beam search engine and based on the input data, a beam search with sampling on a prompt received from a machine learning model to generate a set of output samples; apply an execution-based filter to the set of output samples to determine which of the set of output samples executes properly to generate the output; and provide the output to a user device.

According to some aspects, a method of generating an output from input data is provided. The method includes: applying, by a beam search engine and based on the input data, a beam search on a prompt to generate a set of output samples using a machine learning model; applying an execution-based filter to the set of output samples to determine which of the set of output samples executes properly to generate the output; and providing the output to a user device.

According to some aspects, a non-transitory computer-readable medium storing instructions which, when executed by at least one processor, cause the at least one processor to: apply, by a beam search engine and based on the input data, a beam search with sampling on a prompt received from a machine learning model to generate a set of output samples; apply an execution-based filter to the set of output samples to determine which of the set of output samples executes properly to generate the output; and provide the output to a user device.

According to some aspects, an apparatus to generate an output from input data is provided. The apparatus includes: means for applying, by a beam search engine and based on the input data, a beam search on a prompt to generate a set of output samples using a machine learning model; means for applying an execution-based filter to the set of output samples to determine which of the set of output samples executes properly to generate the output; and providing the output to a user device.

According to some aspects, an apparatus is provided to provide one or more syntax correct samples. The apparatus includes at least one memory and at least one processor coupled to the at least one memory and configured to: generate, based on input data, a prompt; apply a beam search with sampling on the prompt to generate a set of samples; and output the set of samples.

According to some aspects, a method of providing one or more syntax correct samples is provided. The method includes: generating, based on input data, a prompt; applying a beam search with sampling on the prompt to generate a set of samples; and outputting the set of samples.

According to some aspects, a non-transitory computer-readable medium storing instructions which, when executed by at least one processor, cause the at least one processor to: generate, based on input data, a prompt; apply a beam search with sampling on the prompt to generate a set of samples; and output the set of samples.

According to some aspects, an apparatus to provide one or more syntax correct samples is provided. The apparatus includes: means for generating, based on input data, a prompt; means for applying a beam search with sampling on the prompt to generate a set of samples; and means for outputting the set of samples.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a conceptual diagram illustrating a large language model, in accordance with some aspects of this disclosure;

FIG. 2 is a conceptual diagram illustrating an example of computer code generation using a machine learning model, in accordance with some aspects of this disclosure;

FIG. 3A is a block diagram of a natural language generation (NLG) system, in accordance with some aspects of this disclosure;

FIG. 3B is a conceptual diagram illustrating an example of how code retrieval can operate, in accordance with some aspects of this disclosure;

FIG. 4 is a conceptual diagram of a cloud environment with edge nodes or servers, in accordance with some aspects of this disclosure;

FIG. 5A is a flowchart illustrating an example process for code generation performance or to provide output samples associated with a task such as code generation, in accordance with some examples;

FIG. 5B is a flowchart illustrating an example process for providing output samples, in accordance with some examples;

FIG. 5C is a flowchart illustrating an example process for providing output samples, in accordance with some examples;

FIG. 6 is a block diagram illustrating an example of a deep learning network, in accordance with some aspects of this disclosure; and

FIG. 7 is a diagram illustrating an example system architecture for implementing certain aspects described herein, in accordance with some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As noted above, machine learning systems (e.g., deep neural network systems or models) can be used to perform a variety of tasks such as, for example and without limitation, computer code generation, text generation, speech recognition, natural language processing tasks, detection and/or recognition (e.g., scene or object detection and/or recognition, face detection and/or recognition, speech recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

Large language models (LLMs) are one example of machine learning systems. LLMs have been shown to perform code generation with high accuracy. In some examples, LLMs can generate computer code for different programming languages, such as Python, C/C++, Java, SQL, shell, HTML, etc., that can be used to operate a computer system. A number of different types of LLM-based code generation machine learning models exist. LLMs have a large number of parameters. For example, OpenAI GPT4 (Github Copilot X) is one example of an LLM that was estimated to have approximately 1.76 trillion parameters.

Some code generation machine learning models use post-training methods to select code samples based on an execution of LLM-generated tests. One example of a post-training method is based on random sample consensus (RANSAC) models or algorithms (e.g., CodeT). RANSAC is a classical algorithm that finds consensus among noisy data. Such post-training methods incur a large cost and may have robustness issues. Further, such post-training methods may not be reliable in some cases.

Another example of a post-training method includes code self-repair. In some examples, a first LLM (e.g., ChatGPT-4) can be used for feedback on programs generated by a second LLM (e.g., ChatGPT-3.5). In other examples, expert human programmers can be utilized for feedback on the programs generated by an LLM (e.g., ChatGPT-4). However, using a human in the loop or running LLMs with size of ChatGPT-3.5 or ChatGPT-4 at an edge device may not be possible for many use cases.

Another challenge that exists with respect to LLM-based code generation models is that such models include a large number of parameters, including billions and trillions of parameters. Because of the large sizes of LLMs, such LLMs require a large amount of memory and computing power to operate. Other models are not reliable in general or require too much human intervention which increases the cost of use and implementation. Due to such constraints, LLM-based code generation machine learning models are typically operated on powerful computing devices or systems (e.g., cloud computing devices or systems) and cannot be deployed on certain computing devices (e.g., an edge device or node of a network).

Systems and techniques are described herein for performing code generating using machine learning models, such as LLMs. The machine learning models described herein have a reduced parameter requirement (e.g., a reduced number of parameters) and can operate on computing devices with limited resources (e.g., edge devices or nodes within networks) while achieving quality results. For example, the systems and techniques described herein can achieve native cloud-level code generation performance with an edge-class LLM. In some aspects, the systems and techniques can use batching in a sample dimension to improve code generation (or other task) performance and quality in which multiple samples are generated at the same time or in a same time window to balance the compute resources and memory resources. In some cases, the systems and techniques can perform a hybrid artificial intelligence approach in which edge devices can use local compute resources instead of cloud compute resources or a cloud environment could offload compute workload to an edge device. While examples are described herein using the task of code-generation, the systems and techniques can apply to any neural network or machine learning model task when the quality of the generated contents can be assessed objectively.

Various aspects of the application will be described with respect to the figures.

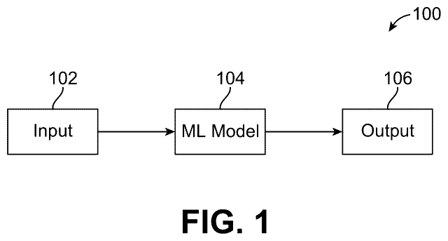

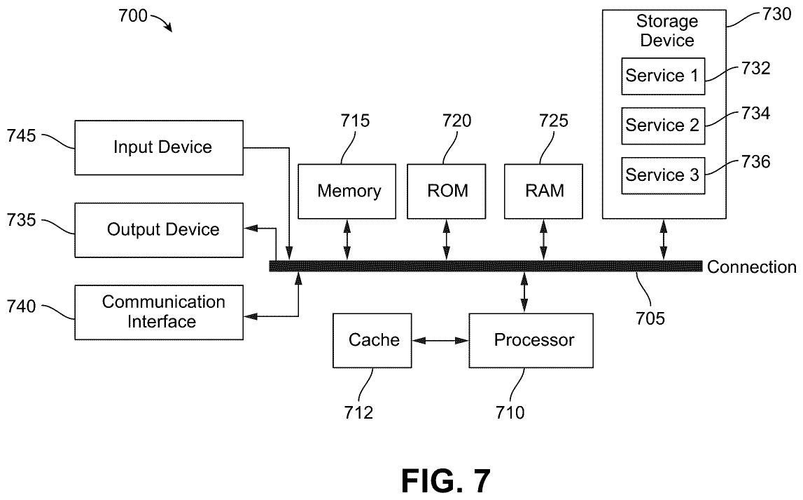

FIG. 1 is a conceptual diagram 100 illustrating operation of a machine learning (ML) model 104. In some examples, the ML model 104 is a large language model (LLM). The input 102 can include a variety of types of input such as a speech waveform that needs to be converted to text as the output 106. The input 102 can include text that needs to have audible speech generated as the output 106. The particular tasks can vary. Examples described herein relate to the task of code generation, where the output 106 can include computer code or a computer program which performs a described function. For example, based on a certain type of input 102, the ML model 104 can generate computer code that can be used to operate a computer system (e.g., the computing system 700 of FIG. 7). However, as noted above, the broader principles disclosed herein can apply to any type of task to be performed by a machine learning model. For instance, the output 106 can represent any type of output (e.g., text, natural language, audible speech, a turn in a conversation, video, images, etc., depending on the task).

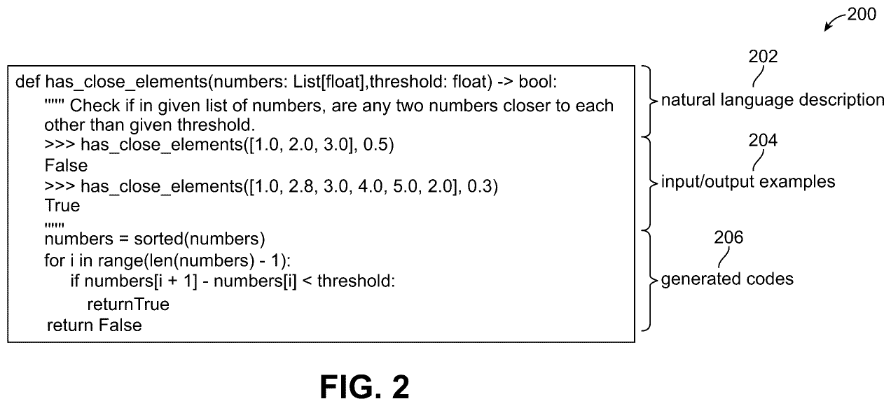

FIG. 2 illustrates examples of inputs and outputs of the ML model 104 of FIG. 1 (e.g., an LLM) trained to generate computer code. When the ML model 104 is used for computer code generation, the input 102 can include a natural language description 202 of a particular task for which a set of computer code is to perform. As shown in FIG. 2, the language describes that the code (defined as “has_close_elements”) should “check if, in given list of numbers, are any two numbers closer to each other than a given threshold”. Several input/output examples 204 can also be provided as part of the input 102. As shown in FIG. 2, a first example of “has_close_elements” data includes the three numbers 1.0, 2.0 and 3.0 and a threshold of 0.5, which results in an answer of “false”. A second example of “has_close_elements” data shown in FIG. 2 includes the six numbers 1.0, 2.8, 3.0, 4.0, 5.0 and 2.0 and a threshold of 0.3, which results in an answer of “true.” Generated code 206 can be output as a computer program that performs the described function based on the natural language description 202 and the input/output examples 204.

The particular task of code generation has different characteristics than other tasks, such as automatic speech recognition. The quality of the generated code 206 of FIG. 2 can be measured. For example, the code can be executed to verify the quality of the generated code 206 based on the output of the executed code. For example, a system such as the ML model 104 of FIG. 1 may include other components that determine whether features (e.g., continuous integration, continuous testing, continuous delivery, etc.) are realized. The ML model 104 may leverage an execution component to verify the quality of the code. Some of the challenges of existing approaches include the concept that the requirements for the description and/or input/output examples can be ambiguous and the space for the generation of the output code can be potentially infinite.

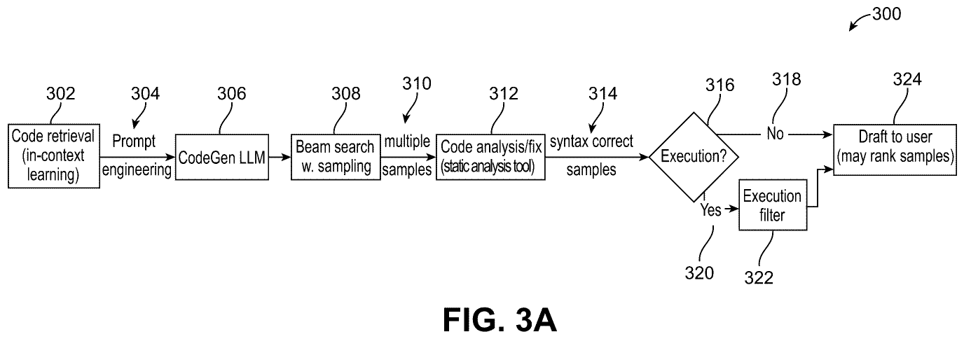

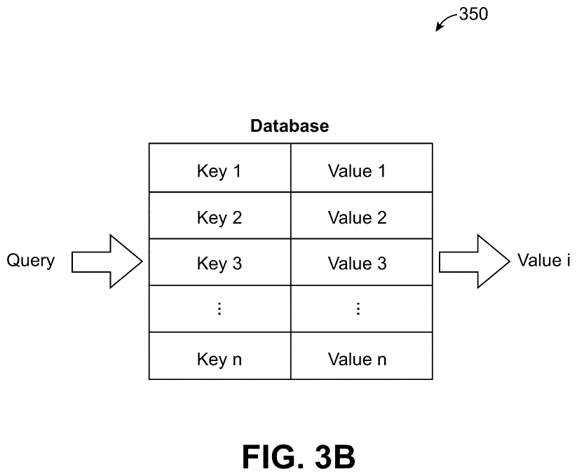

FIG. 3A illustrates an end-to-end solution for an ML system 300 according to the systems and techniques described herein. In some aspects, the ML system 300 can include a code generation LLM-based model. The ML system 300 can include a number of components or engines which can perform particular functions in the overall end-to-end solution. Different aspects of this disclosure include applying one or more of the components in FIG. 3A which result in a particular respective system or aspect.

Most current code generation models focus on using an LLM with greedy or top-k/p sampling. In contrast, the ML system 300 provides an end-to-end solution that improves on tasks such as code generation from an overall system perspective.

A code retrieval engine 302 is one initial component in the ML system 300 that can be used to engineer prompts or to provide prompt engineering. With reference to FIG. 2 and FIG. 3A, high quality natural language descriptions 202 and/or input/output examples 204 when provided to a code generation model 306 can improve the output or generated codes 206. Input data can be provided to the code retrieval engine 302 to generate second input data, which is used for generating a prompt 304. The prompt 304 is received by the code generation model 306. The code generation model 306 can generate an output (e.g., one or more probabilities) based on the prompt 304. The output from the code generation model 306 can then be used by a beam search engine 308 (e.g., which can utilize beam search with sampling) to generate multiple samples 310.

The code retrieval engine 302 can retrieve computer code from a database to help guide the code generation model 306. Different datasets can be used as the database of existing codes. For example, there are public datasets in which one can solve a problem defined by “X” by using a “Y” database. There are textbook classic algorithms that can be accessed in a database. Entities may develop their own code and build an internal codebase.

FIG. 3B illustrates an example code database 350 which receives a query and has key/value pairs that can be used to generate an output value i. The code retrieval engine 302 can encode a query (from a test) and keys (from the database) into dense vector (e.g., sentence transformers). The code retrieval engine 302 can find key(s) whose encoding is close to that of the query. The code retrieval engine 302 can include the keys and values (from the code database 350) as the query into the prompt 304 provided to the code generation model 306. In some aspects, such a process can be referred to as in-context learning, where the input 102 (e.g., the prompt 304) provides a more robust context for the code generation model 306 to operate on to generate the output 106.

In some cases, the process described above with respect to FIG. 3A and FIG. 3B can involve the concept of few-shot learning (FSL). FSL is a machine learning framework that enables a pre-trained model to generalize over new categories of data (that the pre-trained model has not seen during training) using only a few labeled samples per class. The FSL process falls under the paradigm of meta-learning in which meta-learning means learning to learn.

The code retrieval engine 302 can provides relevant portions of code (e.g., code snippets) from the existing code database 350 to aid the LLM computer code generation from the code generation model 306. In some aspects, the code retrieval engine 302 can be part of prompt engineering formatted to improve sample quality as its output can be a set of data that is fed into the code generation model 306 which could be any close/open-source models.

The ML system 300 can include the code generation model 306 and any one or more of the other components shown in FIG. 3A, such as one or more of the code retrieval engine 302 that provides prompt engineering outputs (e.g., the prompt 304), the beam search engine 308 that in some aspects generates multiple samples of generated computer code (or other output), a static analysis engine 312 which can analyze the multiple samples and fix syntax or other problems in the multiple samples to generate syntax correct samples 314, an execution engine 316, and/or an execution filter 322 to ultimately generate an output of high quality output samples 324 for the user. In some cases, a ranking of the output samples can be provided. For example, if the execution filter 322 is not operating or is determined to be bypassed, the output can be ranked for the user as an alternate approach.

The ML system 300 can fully utilize the compute resources available on an edge node, which are typically less than the compute resources available on a cloud server. Use of the ML system 300 can improve sample qualities (e.g., the output samples 324) by performing one or more of the operations of the code retrieval engine 302, the beam search engine 308, the static analysis engine 312, and/or the execution engine 316 which can include the execution filter 322.

In some aspects, the execution filter 322 can filter code samples by execution to test for errors or efficiency. The execution engine 316 can determine that “no” 318, the ML system 300 will not need to or choose not to execute or test the syntax correct samples 314 and simply provide the output samples 324 to the user. The ranking of the samples may occur in that scenario. In other aspects, the execution engine 316 may choose “yes” 320 and apply the execution filter 322 to the syntax correct samples 314 to test the code.

The post-training approach disclosed herein can be generic and directly applied to any model without changes to the model. In one example, a 15B parameter StarCoder model was used by the inventors to demonstrate the effectiveness of the post-training approach.

The output samples 324 or drafts for the user can also include a ranking of the samples based on an estimation of the quality of a respective sample. Such a process can be useful for settings in which executing the generated codes is not possible. In this case, the ML system 300 can rank the samples as noted.

In some aspects, the ML system 300 may provide a few samples in which one of the samples is determined or estimated to be a good sample and user can then select a sample from a few rather than providing one sample that is not acceptable.

The ML system 300 can include subset of component depending on user choice or a desire to balance the complexity and performance in practice. For example, the ML system 300 might include for example the beam search engine 308 (with or without sampling) plus the execution engine 316 and/or the execution filter 322. These components may combine to provide the bare minimum processing with the execution aspect included.

In other aspects, the ML system 300 can include the beam search engine 308 (with or without sampling) to produce multiple samples. This version of the ML system 300 may provide some bare minimum processing without the execution engine 316 or execution filter 322. The ML system 300 can include one, some, or all other components with the code generation model 306.

Generating multiple samples 310 has been performed in some cases for LLM applications. However, such LLM applications use top-k/p sampling methods to generate more samples, which is inefficient and may not provide the sample quality that is needed to achieve native cloud-level task performance such as code generation. The beam search engine 308 or beam-search sampling decoder can generate high-quality samples. Greedy decoding (e.g., a beam width 1) is often used when generating one sample. The greedy decoding process however as noted does not produce multiple diverse samples and therefore its overall performance can be limited comparing to the beam search engine 308. The traditional beam search approach is deterministic and frequently generates samples that are similar to each other and thus lack diversity. Beam search with a sampling component can largely improve the sample quality and thus one aspect of this disclosure includes the feature that the beam search engine 308 includes a sampling component to improve diversity. The sampling can be performed based on a concept of batching across samples. Batching on a sample dimension (rather than on a user dimension which may not be available at the edge layer 406) is one example of how the beam search engine 308 can operate with a sampling component to improve the use of compute resources particularly in an edge node context of a network.

In some aspects, the beam search engine 308 can include but are not limited to beam search sampling, stochastic beam search, and so forth.

Generating high quality samples of computer code can include the use of the static analysis engine 312. In some aspects, an LLM generated samples can make various mistakes, some of which can be detected by the static analysis engine 312 which performs a code analysis and performs a fixing operation to correct syntax. In some studies, as many as 21% of generated samples have syntax errors. Thus, since codes with syntax errors can be detected early in the overall process of the ML system 300, and some of them may be fixed automatically, the use of the static analysis engine 312 can improve sample qualities.

The execution filter 322 can utilize the input/output examples for its filtering purpose. Such input/output examples 204 are frequency provided when the ML system 300 is trained or used for code generation tasks. Thus, although not shown in FIG. 3A, the input/output examples 204 shown in FIG. 2 can be provided to the execution filter 322. These input/output examples 204 are helpful although not sufficient for correctness in the output. The input/output examples 204 can be used to efficiently remove obviously wrong samples.

The inventors have seen a large improvement over other reported numbers in generated samples that pass the execution filter 322 used in the system 300. The improvement in quality samples can be attributed to the improved base model, higher quality multiple samples 310 generated by the beam search engine 308, the static analysis engine 312 and the code retrieval engine 302. In some cases, the dataset used for code retrieval can also provide improvement in the quality of the samples.

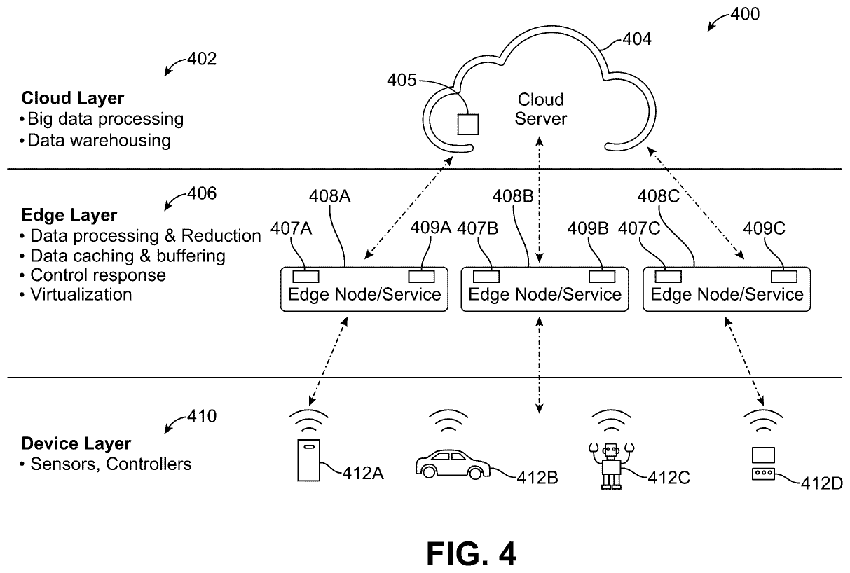

FIG. 4 illustrates an edge computing architecture 400 including a cloud layer 402 with cloud servers 404 that provide big data processing and data warehousing including sufficient compute resources to run an ML model (e.g., the ML model 104 of FIG. 1) as described herein.

The ML model 104 can include an LLM-based code generation machine learning model. An edge layer 406 is provided which performs data processing and reduction, data caching and buffering, control responses and virtualization. FIG. 4 illustrates the application of a hybrid artificial intelligence or hybrid machine learning approach in which a first set of compute resources are applied in the cloud layer 402 and a second set of compute resources are applied the edge layer 406.

A series of edge nodes/servers 408A, 408B, 408C (collectively an edge node/server 408) are illustrated in communication with the cloud layer 402 and various devices 412A, 412B, 412C, 412D in a device layer 410. Today's most popular LLMs are usually based on decoder-only structure; they are memory bound when running single-sample inference. Compute hardware (e.g., such as cloud servers 404 and a computer system 700) is more often idle while waiting for the memory data from DRAM (dynamic random access memory). Typically, the cloud layer 402 addresses the above issues by batching on user dimension. For example, server requests from multiple users can be batched in a time window at the same time. When a batching size is large enough the compute and memory usage can be balanced.

The edge node/server 408 have a different compute requirement than the cloud layer 402 and thus would require different methods to fully utilize the compute resources available due to a lack of the user dimension. In other words, the edge node/server 408 does not necessarily have the ability to batch together server requests from multiple users for efficiency. Speculative decoding uses batching on token verifications to improve single-sample inference. In one example, existing method can include hypothesizing possible continuations proposed by smaller LLMs or retrieved documents and verifying multiple continuations at a same time. The disclosure addresses the issue of fully utilizing compute resource by batching on a sample dimension (rather than on a user dimension which may not be available at the edge layer 406) to improve performance such that multiple samples are generated at the same time to balance the use of compute resources and memory resources of one or more of the cloud layer 402 and/or the edge layer 406.

In some aspects, a hybrid environment can be configured with one or more of the components of the ML system 300 shown in FIG. 3A being configured or operational on the edge layer. These one or more edge machine learning components 407A, 407B, 407C are shown in FIG. 4. In this context, some of the processing can be performed in the edge layer 406. The cloud layer 402 may include one or more cloud machine learning components 405 which again can be one or more of the components of the ML system 300. In another aspect, the edge layer 406 can include all of the ML system 300 which can be configured as represented by components 409A, 409B, 409C. The components 409A, 409B, 409C represent the full operational infrastructure for the ML system 300 on the edge layer 406 which can be configured on one or more of the edge nodes/servers 408A, 408B, 408C.

The disclosed concepts utilize the compute resources and avoid being memory-bound for ML models (e.g., the ML model 104), such as LLMs, and significantly improve the code generation capability and can improve other tasks as well. The capability of LLMs can be substantially improved with proposed techniques. In some cases, smaller LLMs can be made to compete with larger LLMs if they are augmented or configured as disclosed herein. In some cases, larger LLMs can be improved with additional augmentation, and there is no need to increase data center capacity to train even larger LLMs. As noted above, the operations can be distributed in many ways across the edge layer 406 and the cloud layer 402.

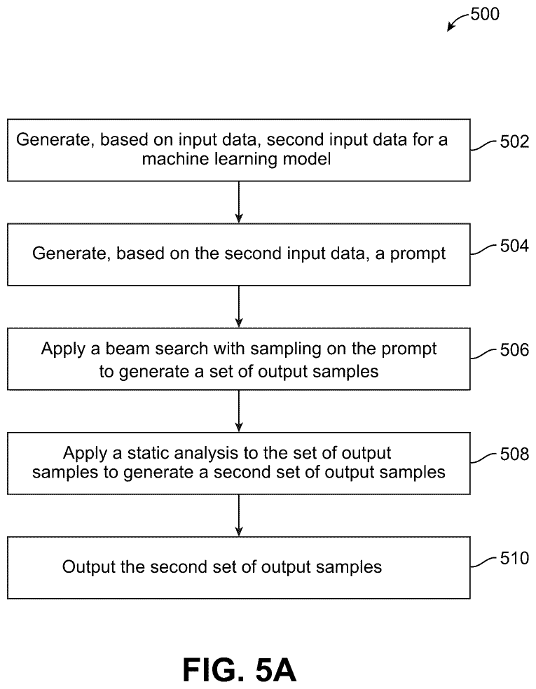

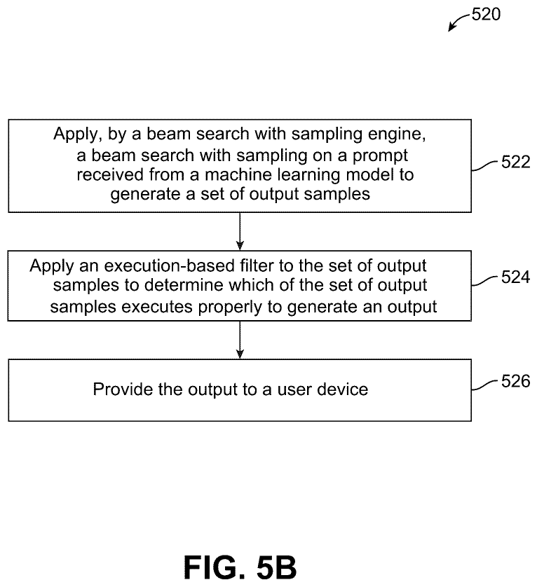

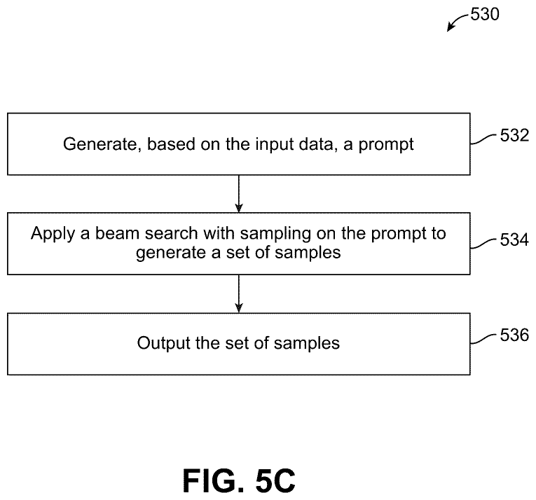

FIG. 5A is a flowchart illustrating an example process 500 for providing an output sample using one or more of the techniques described herein. In one example, the process 500 can be performed by one or more of the ML system 300 and one or more of the code retrieval engine 302, the beam search engine 308, the static analysis engine 312, the execution engine 316 and/or the execution filter 322, the computing system 700, or a combination thereof. For instance, a computing device with the computing device architecture of the computing system 700 shown in FIG. 7 can implement the operations of FIG. 5A and/or the components and/or operations described herein with respect to any of FIGS. 1, 3A, 3B, 4, and/or 6.

At operation 502, the machine learning system (e.g., the ML system 300 or at least one subsystem thereof) can provide one or more syntax correct samples and is configured to, and can, encode the input data (e.g., input data 200 such as a natural language description 202 and input/output examples 204, or other input 102 configured or complementary to the respective task to be performed) to generate, based on the input data, second input data for a machine learning model. In some examples, the input data can include at least one of a natural language description of a process or input-output examples.

In some aspects, the machine learning system may be configured to, and can, generate the second input data by retrieving, from a codebase sample database (e.g., a database 350), computer code to guide the machine learning model. The machine learning model (e.g., ML model 104, such as an LLM) may be trained on a number of different tasks including, but not limited to, the task of generating computer code based on the input data.

In some aspects, the machine learning system may be configured to, and can, generate the second input data by encoding a query associated with the input data and keys from a code retrieval database (e.g., code database 350 of FIG. 3B) into a dense vector and including the query, the keys, and values obtained from the code retrieval database in the input data for the machine learning model, as an example of in-context learning to guide the LLM.

At operation 504, the machine learning system (e.g., the ML system 300 or at least one subsystem thereof) is configured to, and can, generate, based on the second input data, a prompt. In some aspects, the machine learning system is configured to batch on a sample dimension such that the prompt or a group of prompts are generated at a same time. The prompt may include multiple retrieved code snippets.

At operation 506, the machine learning system (e.g., the ML system 300 or at least one subsystem thereof) is configured to, and can, apply a beam search (e.g., via a beam search engine 308 with or without sampling) on the prompt to generate a set of output samples (e.g., the multiple samples 310 shown in FIG. 3A). In some aspects, the beam search can be performed by a stochastic beam search algorithm as part of the beam search engine 308, by adding sampling to a beam search algorithm, or by a sampling method. Examples of sampling methods that can be used include top-k sampling, top-p sampling, any combination thereof, and/or other sampling methods. For instance, top-k sampling can include selecting a next sample randomly from a particular number (k) of samples with the highest probabilities. Top-p sampling can include selecting a next sample randomly from a smallest set of tokens for which a cumulative probability exceeds a specified value (p).

At operation 508, the machine learning system (e.g., the ML system 300 or at least one subsystem thereof) is configured to, and can, apply a static analysis (e.g., via the static analysis engine 312) to the set of output samples to generate a second set of samples (e.g., syntax correct samples 314). The second set of samples can be syntax correct samples in some aspects.

At operation 510, the machine learning system (e.g., the ML system 300 or at least one subsystem thereof) is configured to, and can, output the second set of samples. The second set of samples may be the syntax correct samples 314 or further processing may be provided to generate final draft samples for the user.

In another operation, the machine learning system (e.g., the ML system 300 or at least one subsystem thereof) is configured to, and can, apply an execution-based filter (e.g., execution filter 322) to the set of syntax correct samples to determine at least one syntax correct sample of the set of syntax correct samples executes properly. In some aspects, the execution-based filter 322 can be configured to run the set of syntax correct samples 314 as computer code to determine which of the set of syntax correct samples executes properly. In other aspects when the task is not related to generating computer code, the output (text, video, images, etc.) can be executed or tested in some manner to determine whether it is correct according to the type of data is output based on the task.

In some aspects, the machine learning system is configured on an edge device (e.g., edge devices or edge node/servers 408A, 408B, 408C in FIG. 4).

In some aspects, a non-transitory computer-readable medium having stored thereon instructions which, when executed by one or more processors, cause the one or more processors to perform operations according to any of operations 502-510. In another example, an apparatus can include one or more means for performing operations according to any of operations 502-510.

In some examples, the machine learning system can be an apparatus to provide one or more syntax correct samples, the apparatus can include means for generating, based on input data, a prompt for a machine learning model; means for generating, by the machine learning model based on the prompt, a plurality of output samples; means for applying a beam search with sampling on the prompt to generate a subset of output samples; means for applying a static analysis to the subset of output samples to generate a set of syntax correct samples; and means for outputting the set of syntax correct samples. The means for performing any one or more of these operations can include one or more of the ML system 300 and one or more of the code retrieval engine 302, the beam search engine 308, the static analysis engine 312, the execution engine 316, the execution filter 322, the computing system 700, or a combination or subcomponent thereof. For instance, a computing device with the computing device architecture of the computing system 700 shown in FIG. 7 can implement the operations of FIG. 5A and/or the components and/or operations described herein with respect to any of FIGS. 1, 3A, 3B, 4, and/or 6.

FIG. 5B is a flowchart illustrating an example process 520 for providing an output sample using one or more of the techniques described herein. In one example, the process 520 can be performed by one or more of the ML system 300 and one or more of the code retrieval engine 302, the beam search engine 308, the static analysis engine 312, the execution engine 316 and/or the execution filter 322, the computing system 700, or a combination thereof. For instance, a computing device with the computing device architecture of the computing system 700 shown in FIG. 7 can implement the operations of FIG. 5B and/or the components and/or operations described herein with respect to any of FIGS. 1, 3A, 3B, 4, and/or 6.

At operation 522, the machine learning system (e.g., the ML system 300 or at least one subsystem thereof) is configured to, and can, apply a beam search (e.g., via a beam search engine 308 with or without sampling) on a prompt (which can include multiple retrieved samples) to generate a set of output samples (e.g., the multiple samples 310 shown in FIG. 3A). In some aspects, the beam search can be performed by a stochastic beam search algorithm as part of the beam search engine 308, by adding sampling to a beam search algorithm, or by a sampling method (e.g., top-k sampling, top-p sampling, etc.). The beam search can be a beam search engine (e.g., the beam search engine 308) and can include a sampling component such that the set of output samples is diverse. In some aspects, machine learning system (e.g., the ML system 300 or at least one subsystem thereof) can be configured to generate, based on the input data, second input data for the machine learning model and generate the prompt. The second input data for the machine learning model can be generated using a code retrieval component (e.g., the code retrieval engine 302) that accesses a database (e.g., code database 350) of existing computer case based on the input data to generate the second input data.

At operation 524, the machine learning system (e.g., the ML system 300 or at least one subsystem thereof) is configured to, and can, apply an execution-based filter (e.g., execution filter 322) to the set of output samples to determine at least one syntax correct sample of the set of output samples executes properly to generate an output. In some aspects, the execution-based filter 322 can be configured to run the set of output samples (e.g., the syntax correct samples 314) as computer code to determine which of the set of output samples executes properly. In other aspects when the task is not related to generating computer code, the output (text, video, images, etc.) can be executed or tested in some manner to determine the quality according to the type of output data based on the task.

At operation 526, the machine learning system (e.g., the ML system 300 or at least one subsystem thereof) is configured to, and can, provide the output to a user device. The output can be correct samples which can be the syntax correct samples 314 or further processing may be provided to generate final draft samples for the user.

The machine learning system (e.g., the ML system 300 or at least one subsystem thereof) can also be configured to, and can, apply, via static analysis (e.g., status analysis engine 312), an analysis to the subset of output samples to generate a set of syntax correct samples (e.g., syntax correct samples 314). An execution-based filter (e.g., execution filter 322) can be applied to the set of syntax correct samples.

The machine learning system (e.g., the ML system 300 or at least one subsystem thereof) can also be configured to, and can, batch on a sample dimension such that multiple samples (e.g., the multiple samples 310) are generated at a same time by the machine learning system.

In some aspects, an apparatus (e.g., the ML system 300 or at least one subsystem thereof) to generate an output from input data can include means for applying, by a beam search engine and based on the input data, a beam search with sampling on the prompt received from a machine learning model to generate a set of output samples; means for applying an execution-based filter to the set of output samples to determine which of the set of output samples executes properly to generate the output; and means for providing the output to a user device. The means for performing any one or more of these operations can include one or more of the ML system 300 and one or more of the code retrieval engine 302, the beam search engine 308, the static analysis engine 312, the execution engine 316, the execution filter 322, the computing system 700, or a combination or subcomponent thereof. For instance, a computing device with the computing device architecture of the computing system 700 shown in FIG. 7 can implement the operations of FIG. 5A and/or the components and/or operations described herein with respect to any of FIGS. 1, 3A, 3B, 4, and/or 6.

In another aspect, a non-transitory computer-readable medium storing instructions which, when executed by at least one processor, cause the at least one processor to: apply, by a beam search engine and based on the input data, a beam search on a prompt received from a machine learning model to generate a set of output samples; apply an execution-based filter to the set of output samples to determine which of the set of output samples executes properly to generate the output; and provide the output to a user device.

In some aspects, the machine learning system is configured on one or more of an edge device (e.g., edge devices or edge node/servers 408A, 408B, 408C in FIG. 4) and/or a cloud device (e.g., one or more cloud machine learning components 405 in FIG. 4).

In some aspects, a non-transitory computer-readable medium having stored thereon instructions which, when executed by one or more processors, cause the one or more processors to perform operations according to any of operations 522-526. In another example, an apparatus can include one or more means for performing operations according to any of operations 522-526.

FIG. 5C is a flowchart illustrating an example process 530 for providing an output sample using one or more of the techniques described herein. In one example, the process 530 can be performed by one or more of the ML system 300 and one or more of the code retrieval engine 302, the beam search engine 308, the static analysis engine 312, the execution engine 316 and/or the execution filter 322, the computing system 700, or a combination thereof. For instance, a computing device with the computing device architecture of the computing system 700 shown in FIG. 7 can implement the operations of FIG. 5C and/or the components and/or operations described herein with respect to any of FIGS. 1, 3A, 3B, 4, and/or 6.

At operation 532, the machine learning system (e.g., the ML system 300 or at least one subsystem thereof) is configured to, and can, generate a prompt based on the input data (which can be characterized as the second input data which is generated based on the input data discussed below). In some aspects, the machine learning model is trained to generate computer code based on the input data. Other tasks are contemplated as well beyond the generation of computer code. In some aspects, the machine learning system (e.g., the ML system 300 or at least one subsystem thereof) is configured to, and can, generate the plurality of samples be generating, based on the input data, second input data for the machine learning model. The input data can be used to generate second input data for the machine learning model by retrieving, from a codebase (e.g., the code database 350), sample computer code to guide the machine learning model. The machine learning system (e.g., the ML system 300 or at least one subsystem thereof) is configured to, and can, generate the second input data for the machine learning model to generate the prompt by encoding a query associated with the input data and keys from a code retrieval database into a dense vector and including the query, the keys and values obtained from the code retrieval database into the second input data for the machine learning model.

At operation 534, the machine learning system (e.g., the ML system 300 or at least one subsystem thereof) is configured to, and can, apply a beam search (e.g., from beam search engine 308 with or without sampling) on the prompt to generate a set of samples (e.g., the multiple samples 310). The machine learning system (e.g., the ML system 300 or at least one subsystem thereof) is configured to, and can, apply a static analysis (e.g., by the static analysis engine 312) to the set of samples to generate a set of output samples (e.g., the syntax correct samples 314). The set of output samples can be corrected to have a correct syntax. The machine learning system (e.g., the ML system 300 or at least one subsystem thereof) is configured to, and can, analyze the set of samples for syntax errors and correct the syntax errors in the set of samples to generate the set of output samples. In some aspects, the beam search can be performed by a stochastic beam search algorithm, by adding sampling to a beam search algorithm, or by a sampling method (e.g., top-k sampling, top-p sampling, etc.).

In some aspects, the machine learning system (e.g., the ML system 300 or at least one subsystem thereof) is configured to, and can, batch (e.g., via the beam search engine 308 or some other component of the ML system 300) on a sample dimension such that multiple samples (e.g., the multiple samples 310) are generated at a same time.

At operation 536, the machine learning system (e.g., the ML system 300 or at least one subsystem thereof) is configured to, and can, output the set of output samples.

In some aspects, the machine learning system (e.g., the ML system 300 or at least one subsystem thereof) is configured to, and can, apply an execution-based filter (e.g., execution filter 322) to the set of output samples to determine which of the set of output samples executes properly top generate the output samples 324 for the user.

In some aspects, an apparatus (e.g., the ML system 300 or at least one subsystem thereof) to generate an output from input data can include means for generating, by a machine learning model and based on the input data, a plurality of samples; means for applying a beam search on the plurality of samples to generate a set of samples; and means for outputting the set of samples. The means for performing any one or more of these operations can include one or more of the ML system 300 and one or more of the code retrieval engine 302, the beam search engine 308, the static analysis engine 312, the execution engine 316, the execution filter 322, the computing system 700, or a combination or subcomponent thereof. For instance, a computing device with the computing device architecture of the computing system 700 shown in FIG. 7 can implement the operations of FIG. 5A and/or the components and/or operations described herein with respect to any of FIGS. 1, 3A, 3B, 4, and/or 6.

In another aspect, a non-transitory computer-readable medium storing instructions which, when executed by at least one processor, cause the at least one processor to: generate, by a machine learning model and based on the input data, a plurality of samples; apply a beam search on the plurality of samples to generate a set of samples; and output the set of samples.

In some aspects, the machine learning system is configured on one or more of an edge device (e.g., edge devices or edge node/servers 408A, 408B, 408C in FIG. 4) and/or a cloud device (e.g., one or more cloud machine learning components 405 in FIG. 4).

In some aspects, a non-transitory computer-readable medium having stored thereon instructions which, when executed by one or more processors, cause the one or more processors to perform operations according to any of operations 532-536. In another example, an apparatus can include one or more means for performing operations according to any of operations 532-536.

In some aspects, the processes described herein (e.g., processes 500, 520 and/or 530 and/or any other process described herein) may be performed by a computing device or apparatus. In one example, the processes 500, 520, 530 can be performed by any one or more of the ML system 300 and one or more of the code retrieval engine 302, the beam search engine 308, the static analysis engine 312, the execution engine 316, the execution filter 322, the computing system 700, or a combination or subcomponent thereof. For instance, a computing device with the computing device architecture of the computing system 700 shown in FIG. 7 can implement the operations of FIG. 5A and/or the components and/or operations described herein with respect to any of FIGS. 1, 3A, 3B, 4, 6, and/or 7.

The computing device can include any suitable device, such as a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a server computer, a vehicle (e.g., an autonomous vehicle) or computing device of the vehicle, a robotic device, a laptop computer, a smart television, a camera, and/or any other computing device with the resource capabilities to perform the processes described herein, including the processes 500, 520 and/or 530 and/or any other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes 500, 520 and/or 530 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 500, 520 and/or 530 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

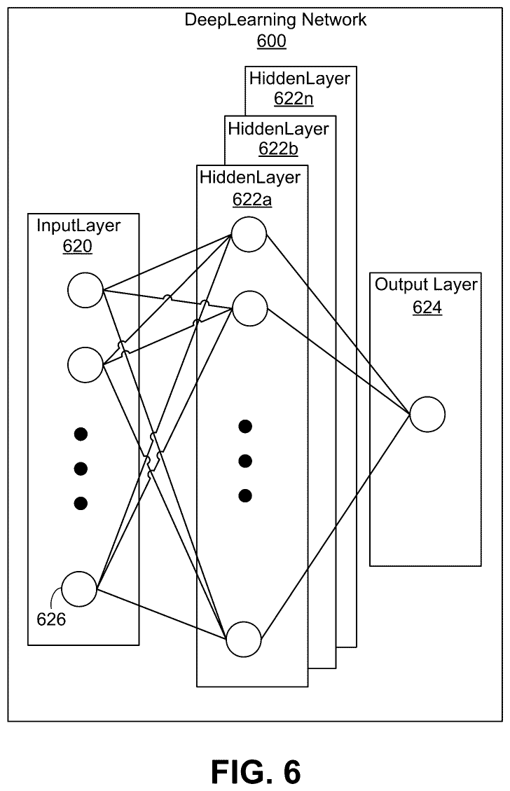

As described herein, the neural network 600 of FIG. 6 may be implemented using a neural network or multiple neural networks. FIG. 6 is an illustrative example of a deep learning neural network 600 that can be used by the neural network 600 of FIG. 6. An input layer 620 includes input data. In one illustrative example, the input layer 620 can include data representing the pixels of an input video frame. The neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network 600 further includes an output layer 624 that provides an output resulting from the processing performed by the hidden layers 622a, 622b, through 622n. In one illustrative example, the output layer 624 can provide a classification for an object in an input video frame. The classification can include a class identifying the type of object (e.g., a person, a dog, a cat, or other object).

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the hidden layers 622a, 622b, through 622n can transform the information of each input node by applying activation functions to the information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 624, at which an output is provided. In some cases, while nodes (e.g., node 626) in the neural network 600 are shown as having multiple output lines, a node has a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 624. In an example in which the neural network 600 is used to identify objects in images, the neural network 600 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 600 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 600 is trained well enough so that the weights of the layers are accurately tuned.

For the example of identifying objects in images, the forward pass can include passing a training image through the neural network 600. The weights are initially randomized before the neural network 600 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 600, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 600 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 600 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

In some cases, the neural network 600 can be trained using self-supervised learning.

The neural network 600 can include any suitable deep network. One example includes a convolutional neural network (CNN), which includes an input layer and an output layer, with multiple hidden layers between the input and out layers. An example of a CNN is described below with respect to FIG. 7. The hidden layers of a CNN include a series of convolutional, nonlinear, pooling (for downsampling), and fully connected layers. The neural network 600 can include any other deep network other than a CNN, such as an autoencoder, a deep belief nets (DBNs), a Recurrent Neural Networks (RNNs), among others.

FIG. 7 is a diagram illustrating an example of a system for implementing certain aspects of the present disclosure. In particular, FIG. 7 illustrates an example of computing system 700, which can be for example any computing device making up a computing system, a camera system, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1202.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable medium (e.g., a memory device) and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically crasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some examples, a hardware service that performs a particular function can include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus to provide one or more syntax correct samples, comprising: at least one memory; and at least one processor coupled to the at least one memory and configured to: generate, based on input data, second input data for a machine learning model; generate, based on the second input data, a prompt; apply a beam search with sampling on the prompt to generate a set of output samples; apply a static analysis to the set of output samples to generate a set of samples; and output the set of samples.

Aspect 2. The apparatus of Aspect 1, wherein the input data comprises at least one of a natural language description of a process or input-output examples.

Aspect 3. The apparatus of any one of Aspects 1 or 2, wherein at least one processor is further configured to: apply an execution-based filter to the set of samples to determine at least one syntax correct sample of the set of samples executes properly.

Aspect 4. The apparatus of Aspect 3, wherein the execution-based filter is configured to run the set of samples as computer code to determine which of the set of samples executes properly.

Aspect 5. The apparatus of any one of Aspects 1 to 4, wherein, to generate the second input data for the machine learning model, the at least one processor is configured to retrieve, from a codebase sample database, computer code to guide the machine learning model.

Aspect 6. The apparatus of any one of Aspects 1 to 5, wherein the machine learning model is trained to generate computer code based on the second input data.

Aspect 7. The apparatus of any one of Aspects 1 to 6, wherein the beam search with sampling is performed by a stochastic beam search, by adding sampling to a beam search algorithm, or by a sampling method.

Aspect 8. The apparatus of any one of Aspects 1 to 7, wherein, to generate the second input data for the machine learning model, the at least one processor is configured to: encode a query associated with the input data and keys from a code retrieval database into a dense vector; and include the query, the keys, and values obtained from the code retrieval database in the second input data for the machine learning model.

Aspect 9. The apparatus of any one of Aspects 1 to 8, wherein, to apply the static analysis to the set of output samples, the at least one processor is configured to: analyze the set of output samples for syntax errors to generate a set of syntax wrong samples; and correct the syntax errors in the set of syntax wrong samples.

Aspect 10. The apparatus of any one of Aspects 1 to 9, wherein the apparatus is configured on one or more of an edge device and a cloud device associated with a cloud-based compute service.

Aspect 11. The apparatus of any one of Aspects 1 to 10, wherein the at least one processor is configured to batch on a sample dimension such that multiple samples are generated at a same time by the apparatus.

Aspect 12. A method of providing one or more syntax correct samples, the method comprising: generating, based on input data, second input data for a machine learning model; generating, based on the second input data, a prompt; applying a beam search with sampling on the prompt to generate a set of output samples; applying a static analysis to the set of output samples to generate a set of samples; and outputting the set of samples.

Aspect 13. The method of Aspect 12, wherein the input data comprises at least one of a natural language description of a process or input-output examples.

Aspect 14. The method of any one of Aspects 12 or 13, further comprising: applying an execution-based filter to the set of samples to determine at least one syntax correct sample of the set of samples executes properly.

Aspect 15. The method of Aspect 14, wherein the execution-based filter is configured to run the set of samples as computer code to determine which of the set of samples executes properly.

Aspect 16. The method of any one of Aspects 12 to 15, wherein generating the second input data for the machine learning model further comprises retrieving, from a codebase sample database, computer code to guide the machine learning model.

Aspect 17. The method of any one of Aspects 12 to 16, wherein the machine learning model is trained to generate computer code based on the input data.

Aspect 18. The method of any one of Aspects 12 to 17, wherein the beam search with sampling is performed by a stochastic beam search, by adding sampling to a beam search algorithm, or by a sampling method.

Aspect 19. The method of any one of Aspects 12 to 18, wherein, generating the second input data for the machine learning model further comprises: encoding a query associated with the input data and keys from a code retrieval database into a dense vector; and including the query, the keys, and values obtained from the code retrieval database in the second input data for the machine learning model.

Aspect 20. The method of any one of Aspects 12 to 19, wherein applying the static analysis to the set of output samples further comprises: analyzing the set of output samples for syntax errors to generate a set of syntax wrong samples; and correcting the syntax errors in the set of syntax wrong samples.

Aspect 21. The method of Aspect 20, wherein the method is performed on one or more of an edge device and a cloud device associated with a cloud-based compute service.

Aspect 22. The method of any one of Aspects 12 to 21, wherein batching on a sample dimension is performed such that multiple samples are generated at a same time.

Aspect 23. An apparatus to provide one or more syntax correct samples, the apparatus comprising one or more means for performing operations according to any of Aspects 12 to 22.

Aspect 24. A non-transitory computer-readable medium storing instructions which, when executed by at least one processor, cause the at least one processor to perform operations according to any of Aspects 12 to 22.

Aspect 25. An apparatus to generate an output from input data, comprising: at least one memory; and at least one processor coupled to the at least one memory and configured to: apply, by a beam search engine and based on the input data, a beam search with sampling on a prompt received from a machine learning model to generate a set of output samples; apply an execution-based filter to the set of output samples to determine which of the set of output samples executes properly to generate the output; and provide the output to a user device.

Aspect 26. The apparatus of Aspect 25, wherein the beam search engine with sampling comprises a sampling component such that the set of output samples is diverse.

Aspect 27. The apparatus of any one of Aspects 25 or 26, wherein the at least one processor is configured to: generate, based on the input data, second input data for the machine learning model; and generate, based on the second input data, the prompt.

Aspect 28. The apparatus of Aspect 27, wherein the at least one processor is configured to generate, based on the input data, the second input data for the machine learning model using a code retrieval component that accesses a database of existing computer case based on the input data to generate the second input data.

Aspect 29. The apparatus of any one of Aspects 27 or 28, wherein the at least one processor is configured to: apply, via a static analysis tool, an analysis to the set of output samples to generate a set of samples, wherein the execution-based filter is applied to the set of samples.

Aspect 30. The apparatus of any one of Aspects 25 to 29, wherein the at least one processor is configured to batch on a sample dimension such that multiple samples are generated at a same time by the apparatus.

Aspect 31. A method for generating an output from input data, the method comprising: applying, by a beam search engine and based on the input data, a beam search on a prompt to generate a set of output samples using a machine learning model; applying an execution-based filter to the set of output samples to determine which of the set of output samples executes properly to generate the output; and providing the output to a user device.

Aspect 32. The method of Aspect 31, wherein the beam search engine comprises a sampling component such that the set of output samples is diverse.

Aspect 33. The method of any one of Aspects 31 or 32, further comprising: generating, based on the input data, second input data for the machine learning model; and generating, based on the second input data, the prompt.

Aspect 34. The method of Aspect 33, further comprising generating, based on the input data, the second input data for the machine learning model using a code retrieval component that accesses a database of existing computer case based on the input data to generate the second input data.

Aspect 35. The method of any one of Aspects 33 or 34, further comprising: applying, via a static analysis tool, an analysis to the set of output samples to generate a set of samples, wherein the execution-based filter is applied to the set of samples.

Aspect 36. The method of any one of Aspects 31 to 35, further comprising batching on a sample dimension such that multiple samples are generated at a same time.

Aspect 37. An apparatus to generate an output from input data, the apparatus comprising one or more means for performing operations according to any of Aspects 31 to 36.

Aspect 38. A non-transitory computer-readable medium storing instructions which, when executed by at least one processor, cause the at least one processor to perform operations according to any of Aspects 31 to 36.

Aspect 39. An apparatus to provide one or more samples, comprising: at least one memory; and at least one processor coupled to the at least one memory and configured to: generate, based on input data, a prompt; apply a beam search with sampling on the prompt to generate a set of samples; and output the set of samples.

Aspect 40. The apparatus of Aspect 39, wherein the beam search is performed by a stochastic beam search algorithm or beam search with a sampling component.

Aspect 41. The apparatus of any one of Aspects 39 or 40, wherein the machine learning model is trained to generate computer code based on the input data.

Aspect 42. The apparatus of any one of Aspects 39 to 41, wherein, to generate the prompt, the at least one processor is configured to generate, based on the input data, second input data for the machine learning model.

Aspect 43. The apparatus of Aspect 42, wherein, to generate, based on the input data, the second input data for the machine learning model, the at least one processor is further configured to retrieve, from a codebase, sample computer code to guide the machine learning model.

Aspect 44. The apparatus of any one of Aspects 42 or 43, wherein, to generate, based on the input data, the second input data for a machine learning model, the at least one processor is configured to: encode a query associated with the input data and keys from a code retrieval database into a dense vector; and include the query, the keys and values obtained from the code retrieval database into the second input data for the machine learning model.

Aspect 45. The apparatus of any one of Aspects 39 to 44, wherein the at least one processor is further configured to: apply a static analysis to the set of samples to generate a set of output samples, wherein the set of output samples have a correct syntax; and output the set of output samples.

Aspect 46. The apparatus of Aspect 45, wherein, to apply the static analysis to the set of samples, the at least one processor is configured to: analyze the set of samples for syntax errors; and correct the syntax errors in the set of samples to generate the set of output samples.

Aspect 47. The apparatus of any one of Aspects 45 or 46, wherein the at least one processor is further configured to: apply an execution-based filter to the set of output samples to determine which of the set of output samples executes properly.

Aspect 48. The apparatus of any one of Aspects 39 to 47, wherein the at least one processor is configured to batch on a sample dimension such that multiple samples are generated at a same time by the apparatus.

Aspect 49. A method of providing one or more samples, the method comprising:
generating, based on input data, a prompt; applying a beam search with sampling on the prompt to generate a set of samples; and outputting the set of samples.

Aspect 50. The method of Aspect 49, wherein the beam search is performed by a stochastic beam search algorithm or beam search with a sampling component.

Aspect 51. The method of any one of Aspects 49 or 50, wherein the machine learning model is trained to generate computer code based on the input data.

Aspect 52. The method of any one of Aspects 49 to 51, wherein generating the prompt further comprises generating, based on the input data, second input data for the machine learning model.

Aspect 53. The method of Aspect 52, wherein generating, based on the input data, the second input data for the machine learning model further comprises retrieving, from a codebase, sample computer code to guide the machine learning model.

Aspect 54. The method of any one of Aspects 52 or 53, wherein generating, based on the input data, the second input data for a machine learning model further comprises: encoding a query associated with the input data and keys from a code retrieval database into a dense vector; and including the query, the keys and values obtained from the code retrieval database into the second input data for the machine learning model.

Aspect 55. The method of any one of Aspects 49 to 54, further comprising: applying a static analysis to the set of samples to generate a set of output samples, wherein the set of output samples have a correct syntax; and outputting the set of output samples.

Aspect 56. The method of Aspect 55, wherein applying the static analysis to the set of samples further comprises: analyzing the set of samples for syntax errors; and correcting the syntax errors in the set of samples to generate the set of output samples.

Aspect 57. The method of any one of Aspects 55 or 56, further comprising: applying an execution-based filter to the set of output samples to determine which of the set of output samples executes properly.

Aspect 58. The method of any one of Aspects 49 to 57, further comprising: batching on a sample dimension such that multiple samples are generated at a same time.

Aspect 59. An apparatus to provide one or more samples, comprising one or more means for performing operations according to any of Aspects 49 to 58.

Aspect 60. A non-transitory computer-readable medium storing instructions which, when executed by at least one processor, cause the at least one processor to perform operations according to any of Aspects 49 to 58.

What is claimed is:

1. An apparatus to provide one or more syntax correct samples, comprising:
at least one memory; and
at least one processor coupled to the at least one memory and configured to:
generate, based on input data, second input data for a machine learning model;
generate, based on the second input data, a prompt;
apply a beam search with sampling on the prompt to generate a set of output samples;
apply a static analysis to the set of output samples to generate a set of samples; and
output the set of samples.

2. The apparatus of claim 1, wherein the input data comprises at least one of a natural language description of a process or input-output examples.

3. The apparatus of claim 1, wherein at least one processor is further configured to:
apply an execution-based filter to the set of samples to determine at least one syntax correct sample of the set of samples executes properly.

4. The apparatus of claim 3, wherein the execution-based filter is configured to run the set of samples as computer code to determine which of the set of samples executes properly.

5. The apparatus of claim 1, wherein, to generate the second input data for the machine learning model, the at least one processor is configured to retrieve, from a codebase sample database, computer code to guide the machine learning model.

6. The apparatus of claim 1, wherein the machine learning model is trained to generate computer code based on the second input data.

7. The apparatus of claim 1, wherein the beam search with sampling is performed by a stochastic beam search, by adding sampling to a beam search algorithm, or by a sampling method.

8. The apparatus of claim 1, wherein, to generate the second input data for the machine learning model, the at least one processor is configured to:
encode a query associated with the input data and keys from a code retrieval database into a dense vector; and
include the query, the keys, and values obtained from the code retrieval database in the second input data for the machine learning model.

9. The apparatus of claim 1, wherein, to apply the static analysis to the set of output samples, the at least one processor is configured to:
analyze the set of output samples for syntax errors to generate a set of syntax wrong samples; and
correct the syntax errors in the set of syntax wrong samples.

10. The apparatus of claim 1, wherein the apparatus is configured on one or more of an edge device and a cloud device associated with a cloud-based compute service.

11. The apparatus of claim 1, wherein the at least one processor is configured to batch on a sample dimension such that multiple samples are generated at a same time by the apparatus.

12. A method of providing one or more syntax correct samples, the method comprising:
generating, based on input data, second input data for a machine learning model;
generating, based on the second input data, a prompt;
applying a beam search with sampling on the prompt to generate a set of output samples; applying a static analysis to the set of output samples to generate a set of samples; and
outputting the set of samples.

13. The method of claim 12, wherein the input data comprises at least one of a natural language description of a process or input-output examples.

14. The method of claim 12, further comprising:
applying an execution-based filter to the set of samples to determine at least one syntax correct sample of the set of samples executes properly.

15. The method of claim 14, wherein the execution-based filter is configured to run the set of samples as computer code to determine which of the set of samples executes properly.

16. The method of claim 12, wherein generating the second input data for the machine learning model further comprises retrieving, from a codebase sample database, computer code to guide the machine learning model.

17. The method of claim 12, wherein the machine learning model is trained to generate computer code based on the input data.

18. The method of claim 12, wherein the beam search with sampling is performed by a stochastic beam search, by adding sampling to a beam search algorithm, or by a sampling method.

19. The method of claim 12, wherein, generating the second input data for the machine learning model further comprises:
encoding a query associated with the input data and keys from a code retrieval database into a dense vector; and
including the query, the keys, and values obtained from the code retrieval database in the second input data for the machine learning model.

20. The method of claim 12, wherein applying the static analysis to the set of output samples further comprises:
analyzing the set of output samples for syntax errors to generate a set of syntax wrong samples; and
correcting the syntax errors in the set of syntax wrong samples.

21. The method of claim 20, wherein the method is performed on one or more of an edge device and a cloud device associated with a cloud-based compute service.

22. The method of claim 12, wherein batching on a sample dimension is performed such that multiple samples are generated at a same time.

23. An apparatus to provide one or more syntax correct samples, the apparatus comprising:
means for generating, based on input data, second input data for a machine learning model;
means for generating, based on the second input data, a prompt;
means for applying a beam search with sampling on the prompt to generate a set of output samples;
means for applying a static analysis to the set of output samples to generate a set of samples; and
means for outputting the set of samples.

24. The apparatus of claim 23, wherein the input data comprises at least one of a natural language description of a process or input-output examples.

25. The apparatus of claim 23, further comprising:
means for applying an execution-based filter to the set of samples to determine at least one syntax correct sample of the set of samples executes properly.

26. The apparatus of claim 23, wherein, to generate the second input data for the machine learning model, the means for generating the second input data is configured to retrieve, from a codebase sample database, computer code to guide the machine learning model.

27. A non-transitory computer-readable medium storing instructions which, when executed by at least one processor, cause the at least one processor to:
generate, based on input data, second input data for a machine learning model;
generate, based on the second input data, a prompt;
apply a beam search with sampling on the prompt to generate a set of output samples;
apply a static analysis to the set of output samples to generate a set of samples; and
output the set of samples.

28. The computer-readable medium of claim 27, wherein the input data comprises at least one of a natural language description of a process or input-output examples.

29. The computer-readable medium of claim 27, wherein the instructions, when executed by the at least one processor, cause the at least one processor to:
apply an execution-based filter to the set of samples to determine at least one syntax correct sample of the set of samples executes properly.

30. The computer-readable medium of claim 27, wherein, to generate the second input data for the machine learning model, the instructions, when executed by the at least one processor, cause the at least one processor to retrieve, from a codebase sample database, computer code to guide the machine learning model.
